(19) United States
(12) Patent Application Publication
(10) Pub. No.: US 2024/0040093 A1
(43) Pub. Date: Feb. 1, 2024

(54) METHOD, APPARATUS, DEVICE, AND SYSTEM FOR CUSTOMIZING MOTION-BASED PROJECTION

(71) Applicant: iView Displays (Hong Kong) Company Limited, Hongkong (CN)

(72) Inventors: Xiang Li, Shenzhen (CN); Mingnei Ding, Shenzhen (CN); Steve Yeung, Hongkong (CN); Zhiqiang Gao, Hongkong (CN)

(21) Appl. No.: 18/379,231

(22) Filed: Oct. 12, 2023

Related U.S. Application Data
(63) Continuation of application No. PCT/CN2021/105293, filed on Jul. 8, 2021.

(30) Foreign Application Priority Data
Apr. 14, 2021 (CN) 202110400923.6

(51) Int. Cl. H04N 9/31; G06T 17/00

(52) U.S. Cl. CPC H04N 9/3185; G06T 17/00

(57) ABSTRACT

Embodiments of the present application provide a method, apparatus, device, and system for customizing motion-based projection. The method executed by an electronic device includes: acquiring a three-dimensional spatial model corresponding to an actual projection environment; acquiring a mounting position of a projection device and positions of at least two target projection regions configured by a user in the three-dimensional spatial model; and sending the mounting position of the projection device and the positions of the at least two target projection regions in the three-dimensional spatial model to the projection device. According to the present application, the movement path for motion-based projection may be customized, the target projection regions traveled by the movement path can be accurately positioned with no need of on-site adjustment, modified and reused at will.

### CROSS-REFERENCE TO RELATED APPLICATIONS

The application is based upon and claims priority to Chinese Patent Application No. 202110400923.6, filed before China National Intellectual Property Administration on Apr. 14, 2021 and entitled “METHOD, APPARATUS, DEVICE, AND SYSTEM FOR CUSTOMIZING MOTION-BASED PROJECTION,” the entire contents of which are incorporated herein by reference.

### TECHNICAL FIELD OF THE INVENTION

Embodiments of the present application relate to the technical field of projection and display, and in particular, relate to a method, apparatus, device, and system for customizing motion-based projection.

### BACKGROUND OF THE INVENTION

In recent years, with rapid development of semiconductor and display technologies, the projection technology is quickly advanced, and a variety of projection devices are available in the market. At present, the motion-based projection technology is desired in various application scenarios, for example, large-scale stages, security and alarming, smart traffic and the like. Specific demands in different scenarios are accommodated by movement of the projection screen in the space.

However, the traditional motion-based projection scheme is not optimal enough. Upon formation of a movement path, adjustment needs to be made for many times in combination with on-site environments. The formation of the movement path is difficult, the cost is high, and adjustment cannot be performed at will.

### SUMMARY OF THE INVENTION

In a first aspect, the embodiments of the present application provide a method for customizing motion-based projection. The method includes: acquiring, by the electronic device, a three-dimensional spatial model corresponding to an actual projection environment; acquiring a mounting position of a projection device and positions of at least two target projection regions configured by a user in the three-dimensional spatial model; and sending the mounting position of the projection device and the positions of the at least two target projection regions in the three-dimensional spatial model to the projection device.

Optionally, the step of acquiring the mounting position of the projection device and the positions of at least two target projection regions configured by the user in the three-dimensional spatial model includes: acquiring the mounting position of the projection device configured by the user in the three-dimensional spatial model; calculating a projection region coverage range of the projection device based on the three-dimensional spatial model, the mounting position of the projection device, and parameter information of the projection device; and acquiring positions of the at least two target projection regions configured by the user within the projection region coverage range.

Optionally, the method further includes: acquiring position coordinates of the mounting position of the projection device and position coordinates of the at least two target projection regions in a coordinate system of the three-dimensional spatial model; converting the position coordinates of the at least two target projection regions in the coordinate system of the three-dimensional spatial model to relative position coordinates in a projection device coordinate system with the mounting position of the projection device as an origin; and sending the relative position coordinates of the at least two target projection regions in the projection device coordinate system to the projection device.

Optionally, the method further includes: acquiring a corresponding projection content configured by the user for each of the at least two target projection regions; establishing a mapping relationship between the at least two target projection regions and the projection contents; and sending the mapping relationship and the projection contents to the projection device.

Optionally, the method further includes: acquiring sizes and positions of the at least two target projection regions configured by the user in the three-dimensional spatial model, and sending the sizes and positions of the at least two target projection regions in the three-dimensional spatial model to the projection device; wherein the sizes and positions of the at least two target projection regions are determined by at least one positioning point in the three-dimensional spatial model and at least one fixed length to the at least one positioning point, or determined by at least two positioning points in the three-dimensional spatial model.

Optionally, the method further includes: calculating, by the projection device based on the mounting position of the projection device and the positions of the at least two target projection regions in the three-dimensional spatial model, projection angles corresponding to the at least two target projection regions; and adjusting a projection direction based on the projection angles corresponding to the at least two target projection regions, and acquiring the projection contents corresponding to the at least two target projection regions to perform motion-based projection.

Optionally, the method further includes: calculating, by the projection device based on the mounting position of the projection device and the positions of the at least two target projection regions in the three-dimensional spatial model, projection angles corresponding to the at least two target projection regions; calculating, based on the sizes of the at least two target projection regions in the three-dimensional spatial model, projection sizes corresponding to the at least two target projection regions; and adjusting the projection direction based on the projection angles corresponding to the at least two target projection regions, and acquiring the projection contents corresponding to the at least two target projection regions, and performing motion-based projection for the projection contents based on the projection sizes.

In a second aspect, the embodiments of the present application further provide an apparatus for customizing motion-based projection. The apparatus includes: a first acquiring module, configured to acquire a three-dimensional spatial model corresponding to an actual projection environment; a second acquiring module, configured to acquire a mounting position of a projection device and positions of at least two target projection regions configured by a user in the three-dimensional spatial model; and a sending module, configured to send the mounting position of the projection device and the positions of the at least two target projection regions in the three-dimensional spatial model to the projection device.

In a third aspect, the embodiments of the present application further provide an electronic device. The electronic device includes: at least one processor; and a memory communicably connected to the at least one processor; wherein the memory stores one or more instructions executable by the at least one processor, wherein at least one processor, when loading and executing the one or more instructions, is caused to perform the method as described above.

In a fourth aspect, the embodiments of the present application further provide a motion-based projection system. The motion-based projection system includes a projection device and the electronic device as described above; wherein the electronic device is communicably connected to the projection device, and configured to: acquire a three-dimensional spatial model corresponding to an actual projection environment; acquire a mounting position of a projection device and positions of at least two target projection regions configured by a user in the three-dimensional spatial model; and send the mounting position of the projection device and the positions of the at least two target projection regions in the three-dimensional spatial model to the projection device; and the projection device is configured to calculate, based on the mounting position of the projection device and the positions of the at least two target projection regions in the three-dimensional spatial model, projection angles corresponding to the at least two target projection regions; and adjust a projection direction based on the projection angles corresponding to the at least two target projection regions to perform motion-based projection.

Optionally, the electronic device is further configured to: acquire a corresponding projection content configured by the user for each of the at least two target projection regions; establish a mapping relationship between the at least two target projection regions and the projection contents; and send the mapping relationship and the projection contents to the projection device; and the projection device is further configured to calculate, based on the mounting position of the projection device and the positions of the at least two target projection regions in the three-dimensional spatial model, projection angles corresponding to the at least two target projection regions; and adjust the projection direction based on the projection angles corresponding to the at least two target projection regions, and acquire the projection contents corresponding to the at least two target projection regions to perform motion-based projection.

Optionally, the electronic device is further configured to acquire sizes and positions of the at least two target projection regions configured by the user in the three-dimensional spatial model; and send the sizes and positions of the at least two target projection regions to the projection device; and the projection device is further configured to: calculate, based on the mounting position of the projection device and the positions of the at least two target projection regions in the three-dimensional spatial model, projection angles corresponding to the at least two target projection regions; calculate, based on the sizes of the at least two target projection regions in the three-dimensional spatial model, projection sizes corresponding to the at least two target projection regions; and adjust the projection direction based on the projection angles corresponding to the at least two target projection regions, and acquire the projection contents corresponding to the at least two target projection regions, and perform motion-based projection for the projection contents based on the projection sizes.

In a fifth aspect, the embodiments of the present application further provide a computer program product. The computer program product includes one or more computer programs stored in a computer-readable storage medium. The computer program includes one or more program instructions, which, when executed by an electronic device, cause the electronic device to perform the method as described above.

In a sixth aspect, the embodiments of the present application further provide a computer-readable storage medium. The computer-readable storage medium stores one or more computer programs, wherein the one or more computer programs, when run by a processor, cause the processor to perform the method as described above.

### BRIEF DESCRIPTION OF DRAWINGS

One or more embodiments are illustrated by way of example, and not by limitation, in the accompanying drawings, wherein components having the same reference numeral designations represent like components throughout. The drawings are not to scale, unless otherwise disclosed.

FIG. 1 is a schematic hardware structural diagram of a motion-based projection device according to an embodiment of the present application.

FIG. 2 is a flowchart of a method for customizing motion-based projection according to the first embodiment of the present application.

FIG. 3 is the flowchart of another method for customizing motion-based projection according to the first embodiment of the present application.

FIG. 4 is a schematic diagram of coordinate conversion between a projection device coordinate system and a coordinate system of a three-dimensional spatial model according to first embodiment of the present application.

FIG. 5 is a schematic structural diagram of an apparatus for customizing motion-based projection according to the second embodiment of the present application.

FIG. 6 is a schematic structural diagram of an electronic device according to the third embodiment of the present application.

FIG. 7 is a schematic structural diagram of a motion-based projection system according to the fourth embodiment of the present application.

### DETAILED DESCRIPTION OF THE INVENTION

For clearer descriptions of the objectives, technical solutions, and advantages of the embodiments of the present application, the following clearly and completely describes the technical solutions in the embodiments of the present application with reference to the accompanying drawings in the embodiments of the present application. Apparently, the described embodiments are merely a part rather than all of the embodiments of the present application. Based on the embodiments of the present application, all other embodiments derived by persons of ordinary skill in the art without any creative efforts shall fall within the protection scope of the present application.

In addition, technical features involved in various embodiments of the present application described hereinafter may be combined as long as these technical features are not in conflict.

As illustrated in FIG. 1, a schematic hardware structural diagram of an optional motion-based projection device 10 according to an embodiment of the present application is given. The motion-based projection device 10 includes a communication unit 11, a calculating unit 12, a motion control unit 13, a projecting unit 14, a correcting unit 15, and a controller 16. The communication unit 11 is connected to the calculating unit 12, the calculating unit 12 is connected to the motion control unit 13, the motion control unit 13 is connected to the projecting unit 14, the projecting unit 14 is connected to the correcting unit 15, and the controller 16 is connected to the communication unit 11, the calculating unit 12, the motion control unit 13, the projecting unit 14, and the correcting unit 15.

The communication unit 11 may be any type of device that communicates with an upper machine using the wired communication technology or wireless communication technology. The wired communication technology includes Ethernet, universal serial bus (USB), and the like; and the wireless communication technology includes Bluetooth, Wi-Fi, mobile communications (2G, 3G, 4G, 5G, and the like), near-field communication (NFC), radio frequency identification (RFID), and the like. The communication unit 11 is configured to acquire mounting position of a motion-based projection device and position information of a target projection region from the upper machine.

In some embodiments, the communication unit 11 is further configured to acquire projection contents from the upper machine. Optionally, the projection contents one-to-one correspond to the target projection positions.

The calculating unit 12 may be any type of device having a calculation capability, for example, a small-size computer, or a microcontroller unit, or the like. The communication unit 12 is configured to calculate, based on the mounting position of the motion-based projection device and the position information of the target projection region, an angle by which the motion control unit 13 needs to be rotated.

The motion control unit 13 may be any type of device capable of rotating in the horizontal and vertical directions, for example, a pan-tilt-zoom camera or a multi-dimensional motion platform. The motion control unit 13 is configured to control the projecting unit 14 to rotate. For accurate control of a rotation angle of the projecting unit 14, the motion control unit 13 includes a rotation shaft, a motor, and an encoder. The motor may be a stepping motor or a servo motor. The motor is connected to the rotation shaft and the encoder. The rotation shaft is configured to drive the motor to rotate. The encoder is configured to record a rotation position of the motor.

The projecting unit 14 may be any type of device having a projection function, for example, a long-focus projector optical engine. The long-focus projector optical engine is capable of ensuring projection of a projection screen to a distant position, and ensuring an appropriate screen and brightness. The projecting unit 14 is configured to project an image, a video, an animation, or the like content.

The controller 16 is configured to control the communication unit 11 is configured to acquire the mounting position of the motion-based projection device and the position information of the target projection region from the upper machine. The controller is configured to control the calculating unit 12 to calculate a rotation angle based on the position information, and is further configured to control the motion control unit 13 to control the projecting unit 14 to rotate, and control the projecting unit 14 to project a screen.

In some other embodiments, movement of the projection screen may be controlled in two ways. The projecting unit 14 is mounted on the motion control unit 13, and the movement of the projection screen is controlled by rotating the projecting unit 14. Alternatively, the motion-based projection device 10 further includes a reflective mirror. The reflective mirror is mounted on the motion control unit 13, and is placed to be vertical to the projecting unit 14, and the movement of the projection screen is controlled by rotating the reflective mirror. It should be noted that when the reflective mirror is placed to be vertical to the projecting unit 14, the reflective mirror needs to have a high reflectivity, for example, a light incident angle is less than or equal to 45 degrees, and the reflectivity is greater than or equal to 99%.

In some other embodiments, the motion-based projection device 10 further includes a correcting unit 15. The correcting unit 15 may be any type of device having a correction function. During the movement of the projection screen, distortion of the screen inevitably occurs, which greatly affects the perception of a user. By using the correcting unit 15, a trapezoidal screen may be corrected to a normal screen. Through testing, the coordinates of a projector are used as an origin, correction performance is good within the range of ±40° in the horizontal and vertical directions, and a correction effect is poor beyond this range.

In some other embodiments, the motion-based projection device further includes a lens (not illustrated) and a focusing device (not illustrated). The lens is connected to the focusing device, and the focusing device is connected to the controller 16. The controller 16 controls the focusing device to move the lens to a focusing position, such that automatic focusing is implemented.

A method for customizing motion-based projection according to the embodiments of the present application can be applied in various application prospects. For example, the method may be applicable to security, commerce, entertainment, stages, and the like scenarios.

### First Embodiment

The first embodiment of the present application provides a method for customizing motion-based projection. It should be noted that the steps illustrated in the attached flowchart may be performed in a computer system with a group of computer-executable instructions. In addition, although the logic sequence is illustrated in the flowchart, in some cases, the steps illustrated or described may also be performed in a sequence that is different from the logic sequence illustrated in the flowchart.

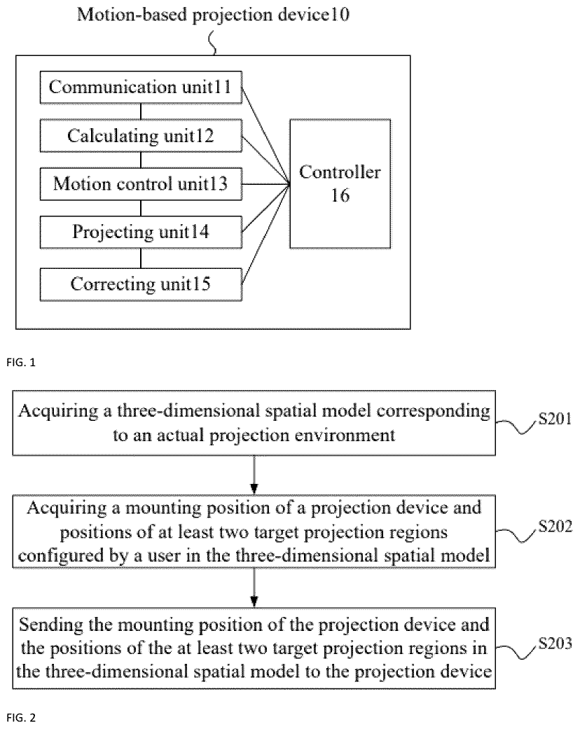

As illustrated in FIG. 2, a flowchart of a method for customizing motion-based projection according to the first embodiment of present application is given. The method is applicable to an electronic device. The electronic device may be of any type of terminals including a display unit, a processor, a memory, and a communication unit, and may specifically be a mobile phone, a tablet, a notebook, a PC or the like. The method includes the following steps.

In step S201, the electronic device acquires a three-dimensional spatial model corresponding to an actual projection environment.

Specifically, the three-dimensional spatial model of the actual projection environment is established by scanning a space environment with an infrared three-dimensional tester or a camera in advance, and the three-dimensional spatial model is stored on the electronic device or on a server. A user selects the three-dimensional spatial model corresponding to the actual projection environment for display.

In step S202, the electronic device acquires a mounting position of a projection device and positions of at least two target projection regions configured by the user in the three-dimensional spatial model.

In alternative embodiments, in response to acquiring the three-dimensional spatial model corresponding to the actual projection environment, the electronic device acquires the projection device selected by the user, that is, the motion-based projection device as described in the embodiment as illustrated in FIG. 1. Different projection devices have different projection region coverage ranges due to different parameters. For example, in the case that the projection device using a reflective mirror for motion-based projection is placed horizontally in a space and the reflective mirror is also placed horizontally, depending on different distances between a surface of the reflective mirror and a projector optical engine, the projection device will have different projection blind zones between a ceiling and a floor, that is, the projection region coverage ranges are different. Step S202 further includes: acquiring the mounting position of the projection device configured by the user in the three-dimensional spatial model; calculating a projection region coverage range of the projection device based on the three-dimensional spatial model, the mounting position of the projection device, and parameter information of the projection device; and acquiring positions of the at least two target projection regions configured by the user within the projection region coverage range. The mounting position of the projection device includes the position where the projection device is placed in the three-dimensional spatial model and an orientation of a projection lens. The position of the target projection region is the position of a center of a projection screen.

In order to facilitate calculation of a deflection angle of the projection screen by the projection device, a coordinate system with the projection device as an origin may be established, the position coordinates of the at least two target projection regions in the coordinate system of the three-dimensional spatial model are converted to relative position coordinates in the coordinate system of the projection device with the mounting position of the projection device as the origin, and the relative position coordinates are sent to the projection device. Specifically, the position coordinates of the mounting position of the projection device in the coordinate system of the three-dimensional spatial model and the position coordinates of the at least two target projection regions in the coordinate system of the three-dimensional spatial model are acquired; the position coordinates of the at least two target projection regions in the coordinate system of the three-dimensional spatial model are converted to the relative position coordinates in the coordinate system of the projection device with the mounting position of the projection device as the origin; and the relative position coordinates of the at least two target projection regions in the coordinate system of the projection device are sent to the projection device.

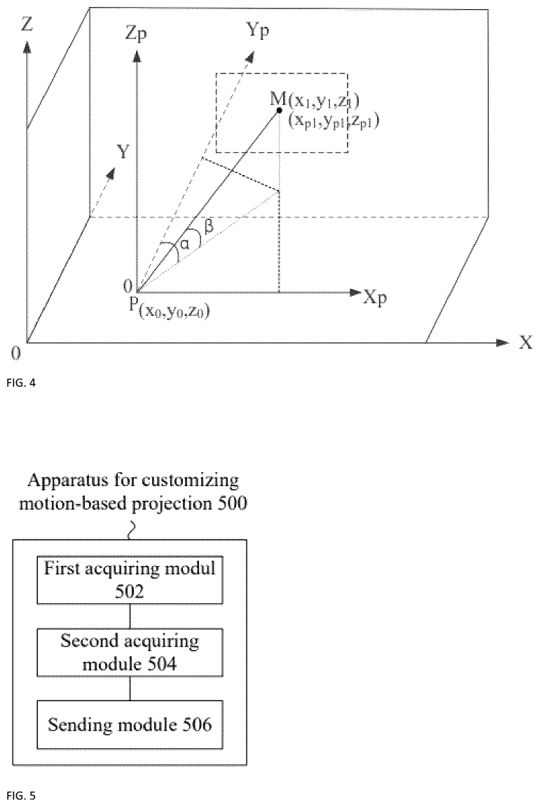

As illustrated in FIG. 4, a schematic diagram of coordinate conversion between a projection device coordinate system and a coordinate system of a three-dimensional spatial model according to the first embodiment of the present application is given. In FIG. 4, a coordinate system (X, Y, Z) of the three-dimensional spatial model is a coordinate system with coordinates of a lower left corner in the three-dimensional spatial model as an origin, a horizontal rightward direction in the three-dimensional spatial model as an X axis, a vertical inward direction in the three-dimensional spatial model as a Y axis, and the direction of a vertical line in the three-dimensional spatial model as a Z axis. The projection device is placed horizontally at a point P facing towards at least two target projection regions. An initial optical axis direction is vertical inward and consistent with the Y axis, and the coordinates are (x₀, y₀, z₀). The coordinates of a position point M of the at least two target projection regions in the coordinate system of the three-dimensional spatial model are (x₁, y₁, z₁). The coordinate system (Xₚ, Yₚ, Zₚ) of the projection device is a coordinate system with a center P (x₀, y₀, z₀) of the projection device as an origin, a horizontal rightward direction as an Xp axis, an initial optical axis direction as a Yp axis, and a vertical upward direction as a Zp axis. The coordinates of the position point M of the at least two target projection regions in the coordinate system of the projection device are (xₚ₁, yₚ₁, zₚ₁), wherein:

xₚ₁=x₁−x₀; yₚ₁=y₁−y₀; zₚ₁=z₁−z₀;

In this way, the relative position coordinates of the at least two target projection regions in the coordinate system of the projection device are acquired.

In addition to controlling the movement of the projection screen, the motion-based projection also includes projecting different projection contents in different projection regions. In some embodiments, the method further includes: acquiring a corresponding projection content configured by the user for each of the at least two target projection regions; establishing a mapping relationship between the at least two target projection regions and the projection contents; and sending the mapping relationship and the projection contents to the projection device. The at least two target projection regions may correspond to different time segments of the same projection content file, or correspond to different projection content files. In the case that the at least two target projection regions correspond to different time segments of the same projection content file, the mapping relationship is a mapping between the at least two target projection regions and start play time and end play time of the projection content file. In the case that the at least two target projection regions correspond to different projection content files, the mapping relationship is a mapping between the target projection regions and the projection content files. In some embodiments, the user may not only configure positions of the at least two

target projection regions in the electronic device, but also configure the sizes of the at least two target projection regions. The method further includes: acquiring sizes and positions of the at least two target projection regions configured by the user in the three-dimensional spatial model, and sending the sizes and positions of the at least two target projection regions in the three-dimensional spatial model to the projection device; wherein the sizes and positions of the at least two target projection regions are determined by at least one positioning point in the three-dimensional spatial model and at least one fixed length to the at least one positioning point, or determined by at least two positioning points in the three-dimensional spatial model. Specifically, the user may configure the mounting position of the projection device and the positions, or the sizes and positions of at least two target projection regions by clicking a position or by dragging a select box in the three-dimensional spatial model. For example, the size and position of a rectangular target projection region are determined by selecting diagonal position points, wherein the two diagonal position points are positioning points; or the size and position of a circular target projection region are determined by dragging a circular select box. In this case, the position of the center of circle is the positioning point, and the size and position of the circular target projection region are determined by the center of circle and a radius of the circle. It should be noted that the shape of the target projection region is not limited in the embodiments of the present application, and those skilled in the art may define target projection regions in different shapes according to actual needs.

In step S203, the electronic device sends the mounting position of the projection device and the positions of the at least two target projection regions in the three-dimensional spatial model to the projection device.

The projection device calculates, based on the mounting position of the projection device and the positions of the at least two target projection regions in the three-dimensional spatial model, projection angles corresponding to the at least two target projection regions; and adjusts a projection direction to perform motion-based projection.

It is understandable that the electronic device further sends the sizes and positions of the at least two target projection regions in the three-dimensional spatial model to the projection device; sends the mapping relationship between the at least two target projection regions and the projection contents, and all projection contents to the projection device, such that the projection device may not only perform projection based on the calculated projection angles, but also acquire the projection contents corresponding to the at least two target projection regions and calculate the projection sizes corresponding to at least two target projection regions; and performs customized motion-based projection based on the projection angles, projection contents and projection sizes.

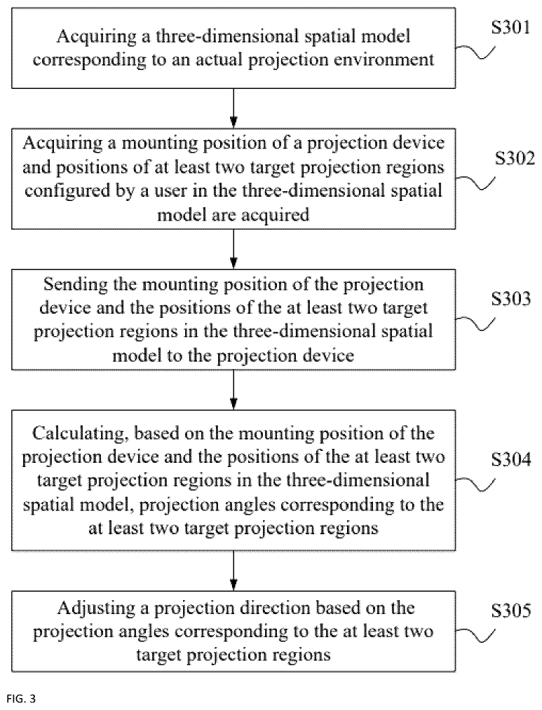

As illustrated in FIG. 3, a flowchart of another method for customizing motion-based projection according to the first embodiment of the present application is given. The method is applicable to the motion-based projection system according to the fourth embodiment. The motion-based projection system includes a projection device and an electronic device, wherein the projection device and the electronic device are communicably connected. The electronic device may be any type of terminals including a display unit, a processor, a memory, and a communication unit, and specifically may be a mobile phone, a tablet, a notebook, a PC, or the like. The projection device is the motion-based projection device as illustrated in FIG. 1. The method includes the following steps.

In step S301, the electronic device acquires a three-dimensional spatial model corresponding to an actual projection environment.

In step S302, the electronic device acquires a mounting position of a projection device and positions of at least two target projection regions configured by a user in the three-dimensional spatial model.

In step S303, the electronic device sends the mounting position of the projection device and the positions of the at least two target projection regions in the three-dimensional spatial model to the projection device.

Steps S301 to S303 are the same as the those in the embodiment as illustrated in FIG. 2, which are not described herein any further.

In step S304, the projection device calculates, based on the mounting position of the projection device and the positions of the at least two target projection regions in the three-dimensional spatial model, projection angles corresponding to the at least two target projection regions.

As illustrated in FIG. 4, description is given using the coordinate system of the projection device as an example. In the case that a center point of a projection screen is in an initial optical axis direction of the projection device, the projection screen is considered to be undeflected. Where it is desired to place a center of the projection screen at the position point M of the target projection region, the projection screen needs to be deflected by an angle of a in the horizontal direction and by an angle of β in the vertical direction. According to the trigonometric function relationship, the following equations may be obtained:

$$α = {tan}^{- 1} ( \frac{{x}_{p 1}}{{y}_{p 1}} ) \\ β = {tan}^{- 1} ( \frac{{z}_{p 1}}{\sqrt{{x}_{p 1}^{2} + {y}_{p 1}^{2}}} ) .$$

According to the equations, the projection angles α and β corresponding to the target projection region may be calculated.

In step S305, the projection device adjusts a projection direction based on the projection angles corresponding to the at least two target projection regions.

Specifically, the projection device may calculate a rotation angle of the motion control unit based on the deflection angles of the projection screen. Specifically, in the case that the three-dimensional spatial coordinates of the position points of the at least two target projection regions in the coordinate system of the projection device are acquired, two angle sequences α⁽ⁱ⁾ and β⁽ⁱ⁾ may be established, wherein i=1, 2, . . . , n. It is assumed that the deflection angles of the projection screen of the current target projection region are α⁽ⁱ⁾ and β⁽ⁱ⁾, then the deflection angles of the projection screen of the next target projection region are α⁽ⁱ⁺¹⁾ and β⁽ⁱ⁺¹⁾ and then the desired rotation angle of the motion control unit in the projection device is:

Δα=α⁽ⁱ⁺¹⁾−α⁽ⁱ⁾

Δβ=β⁽ⁱ⁺¹⁾−β⁽ⁱ⁾.

Δα represents the rotation angle of the motion control unit in the horizontal direction, and Δβ represents the rotation angle of the motion control unit in the vertical direction.

In some embodiments, the electronic device further sends the mapping relationship between the at least two target projection regions and the projection contents, and all projection contents to the projection device. The method further includes: calculating, based on the mounting position of the projection device and the positions of the at least two target projection regions in the three-dimensional spatial model, projection angles corresponding to the at least two target projection regions; and adjusting the projection direction based on the projection angles corresponding to the at least two target projection regions, and acquiring the projection contents corresponding to the at least two target projection regions to perform motion-based projection.

In some embodiments, the electronic device further sends the sizes and positions of the at least two target projection regions in the three-dimensional spatial model to the projection device. The method further includes: calculating, based on the mounting position of the projection device and the positions of the at least two target projection regions in the three-dimensional spatial model, projection angles corresponding to the at least two target projection regions; calculating, based on the sizes of the at least two target projection regions in the three-dimensional spatial model, projection sizes corresponding to the at least two target projection regions; and adjusting the projection direction based on the projection angles corresponding to the at least two target projection regions, and acquiring the projection contents corresponding to the at least two target projection regions, and performing motion-based projection for the projection contents based on the projection sizes.

Description is given hereinafter using the rectangular target projection region as an example. It is assumed that the user clicks an upper left corner position D1 (x_{d1}, y_{d1}, z_{d1}) and a lower right corner position D2 (x_{d2}, y_{d2}, z_{d2}) in the coordinate system of the three-dimensional spatial model to select the position and size of the target projection region, then during the projection, the center of the projection screen needs to be placed at a center point Dm (x_{dm}, y_{dm}, z_{dm}) of the target projection region, wherein

x_{dm}=(x_{d2}−x_{d1})/2; y_{dm}=(y_{d2}−y_{d1})/2; z_{dm}=(z_{d2}−z_{d1})/2;

The projection angles corresponding to the target projection regions may be acquired by using the method as described above.

Further, the projection size of the rectangular target projection region may be calculated according to the upper left corner position D1 (x_{d1}, y_{d1}, z_{d1}) and the lower right corner position D2 (x_{d2}, y_{d2}, z_{d2}), wherein a length of projection region is equal to x_{d2}-x_{d1}, and a width of the projection region is equal to z_{d2}-z_{d1}. In the case that coordinate values in the three-dimensional spatial coordinate system are scaled-down coordinate values, the projection size needs to be correspondingly enlarged according to the scaling ratio of the three-dimensional space model and the actual projection environment.

In the method for customizing motion-based projection according to the embodiments of the present application, first, a three-dimensional spatial model corresponding to an actual projection environment is acquired by an electronic device; second, a mounting position of a projection device and positions of at least two target projection regions configured by a user in the three-dimensional spatial model are acquired; and finally, the mounting position of the projection device and the positions of the at least two target projection regions in the three-dimensional spatial model are sent to the projection device, such that the projection device calculates projection angles corresponding to the at least two target projection regions based on the mounting position of the projection device and the positions of the at least two target projection regions in the three-dimensional spatial model, and adjusts a projection direction based on the projection angles corresponding to the at least two target projection regions to perform motion-based projection. According to the present application, the movement path for motion-based projection may be customized, the target projection regions traveled by the movement path are accurately positioned with no need of on-site adjustment, and the movement path may be modified and reused at will.

### Second Embodiment

A second embodiment of the present application provides an apparatus for customizing motion-based projection. As illustrated in FIG. 5, a schematic structural diagram of an optional apparatus 500 for customizing motion-based projection according to the second embodiment of the present application is given. The apparatus 500 includes:

a first acquiring module 502, configured to acquire a three-dimensional spatial model corresponding to an actual projection environment;

a second acquiring module 504, configured to acquire a mounting position of a projection device and positions of at least two target projection regions configured by a user in the three-dimensional spatial model; and

a sending module 506, configured to send the mounting position of the projection device and the positions of the at least two target projection regions in the three-dimensional spatial model to the projection device.

The above apparatus may perform the method for customizing motion-based projection according to the first embodiment as illustrated in FIG. 2, have the corresponding function modules to perform the method, and achieve the corresponding beneficial effects. For technical details that are not illustrated in detail in this embodiment, reference may be made to the description of the method for customizing motion-based projection according to the first embodiment as illustrated in FIG. 2.

### Third Embodiment

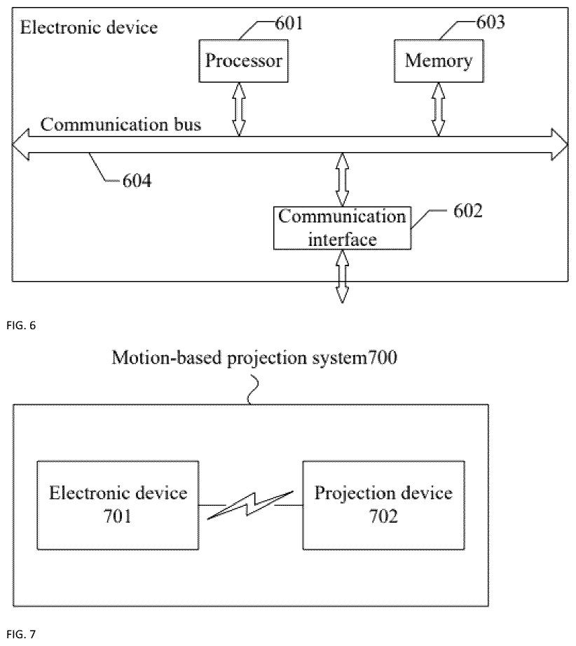

A third embodiment of the present application provides an electronic device according to an embodiment of the present application. As illustrated in FIG. 6, a schematic structural diagram of an optional electronic device according to the third embodiment of the present application is given. The electronic device may include one or more processors 601 (In FIG. 6, one processor 601 is taken as an example), a communication interface 602, a memory 603, and a communication bus 604. The processor 601, the communication interface 602, and the memory 603 communicate with each other via the communication bus 604. The memory 603, as a computer readable storage medium, may be configured to store software programs, computer executable programs and modules, for example, the program instructions/modules (modules 502 to 506 in FIG. 5) corresponding to the method for customizing motion-based projection according to the embodiments of the present application. The software programs, instructions and modules stored in the memory 603, when executed, cause the processor 601 to perform various function applications and data processing of the electronic device, that is, performing the method for customizing motion-based projection according to the above method embodiments.

The memory 603 may include a program memory area and data memory area, wherein the program memory area may store operation systems and application programs needed by at least function; and the data memory area may store data created according to the usage of the apparatuses for customizing motion-based projection. In addition, the memory 603 may include a high-speed random-access memory, or include a non-volatile memory, for example, at least one disk storage device, a flash memory device, or another non-volatile solid storage device. In some embodiments, the memory 603 optionally includes memories remotely configured relative to the processor 610. These memories may be connected to the apparatus for customizing motion-based projection over a network. Examples of the above network include, but not limited to, the Internet, Intranet, local area network, mobile communication network and a combination thereof.

One or a plurality of modules are stored in the memory 603, and when being executed by the at least one processor 601, perform the method for customizing motion-based projection according to any of the above method embodiments, for example, performing step S201 to step S203 in the method as illustrated in FIG. 2 and step S301 to step S305 in the method as illustrated in FIG. 3, and implementing the functions of modules 502 to 506 as illustrated in FIG. 5.

The product may perform the method according to the embodiments of the present application, has corresponding function modules for performing the method, and achieves the corresponding beneficial effects. For technical details that are not illustrated in detail in this embodiment, reference may be made to the description of the methods according to the embodiments of the present application.

The electronic device according to the embodiment of the present application is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;

(2) an ultra mobile personal computer device: which pertains to the category of personal computers and has the computing and processing functions, and additionally has the mobile Internet access feature; such terminals include: a PDA, a MID, a UMPC device and the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device;

(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device; and

(5) another electronic device having the data interaction function.

### Fourth Embodiment

A fourth embodiment of the present application provides a system for customizing motion-based projection. As illustrated in FIG. 7, a schematic structural diagram of an optional motion-based projection system according to the fourth embodiment of the present application is given. The system includes a projection device 702 and an electronic device 701. The electronic device 701 is the electronic device as described in the third embodiment, and the projection device 702 is the motion-based projection device as illustrated in FIG. 1.

Specifically, the electronic device 701 is communicably connected to the projection device 702, and configured to: acquire a three-dimensional spatial model corresponding to an actual projection environment; acquire a mounting position of a projection device and positions of at least two target projection regions configured by a user in the three-dimensional spatial model; and send the mounting position of the projection device and the positions of the at least two target projection regions in the three-dimensional spatial model to the projection device 702.

The projection device 702 is configured to calculate, based on the mounting position of the projection device and the positions of the at least two target projection regions in the three-dimensional spatial model, projection angles corresponding to the at least two target projection regions; and adjust a projection direction based on the projection angles corresponding to the at least two target projection regions to perform motion-based projection.

As illustrated in FIG. 4, description is given using the coordinate system of the projection device as an example. In the case that a center point of a projection screen is in an initial optical axis direction of the projection device, the projection screen is considered to be undeflected. Where it is desired to place a center of the projection screen at the central point M of the target projection region, the projection screen needs to be deflected by an angle of α in the horizontal direction and by an angle of β in the vertical direction (that is, the projection angles corresponding to the target projection region). According to the trigonometric function relationship, the following equations may be obtained:

$$α = {tan}^{- 1} ( \frac{xp 1}{yp 1} ) \\ β = {tan}^{- 1} ( \frac{zp 1}{\sqrt{xp {1}^{2} + yp {1}^{2}}} )$$

Accordingly, the deflection angles α and β of the projection screen in the horizontal and vertical directions may be acquired. Further, the projection device may calculate a rotation angle of the motion control unit based on the deflection angles of the projection screen.

Specifically, in the case that the three-dimensional spatial coordinates of the central point of the at least two target projection regions in the coordinate system of the projection device are acquired, two angle sequences α⁽ⁱ⁾ and β⁽ⁱ⁾ may be established, wherein i=1, 2, . . . , n. It is assumed that the deflection angles of the projection screen of the current target projection region are α⁽ⁱ⁾ and β⁽ⁱ⁾, then the deflection angles of the projection screen of the next target projection region are α⁽ⁱ⁺¹⁾ and β⁽ⁱ⁺¹⁾, and then the desired rotation angle of the motion control unit in the projection device is represented by:

Δα=α⁽ⁱ⁺¹⁾−α⁽ⁱ⁾

Δβ=β⁽ⁱ⁺¹⁾−β⁽ⁱ⁾

Δα represents the rotation angle of the motion control unit in the horizontal direction, and Δβ represents the rotation angle of the motion control unit in the vertical direction.

In some embodiments, the electronic device 701 is further configured to acquire a corresponding projection content configured by the user for each of the at least two target projection regions; establish a mapping relationship between the at least two projection regions and the projection contents; and send the mapping relationship and all projection contents to the projection device 702. The projection device 702 is further configured to calculate, based on the mounting position of the projection device and the positions of the at least two target projection regions in the three-dimensional spatial model, projection angles corresponding to the at least two target projection regions; and adjust the projection direction based on the projection angles corresponding to the at least two target projection regions, acquire the projection contents corresponding to the at least two target projection regions, and perform motion-based projection for the projection contents.

In some embodiments, the electronic device 701 is further configured to acquire sizes and positions of the at least two target projection regions configured by the user in the three-dimensional spatial model, and send the sizes and positions of the at least two target projection regions to the projection device 702. The projection device 702 is further configured to calculate, based on the mounting position of the projection device and the positions of the at least two target projection regions in the three-dimensional spatial model, projection angles corresponding to the at least two target projection regions; calculate, based on the sizes of the at least two target projection regions in the three-dimensional spatial mode, projection sizes corresponding to the at least two target projection regions; and adjust the projection direction based on the projection angles corresponding to the at least two target projection regions, acquire the projection contents corresponding to the at least two target projection regions, and perform motion-based projection for the projection contents based on the projection sizes.

In the system for customizing motion-based projection according to the embodiments of the present application, first, a three-dimensional spatial model corresponding to an actual projection environment is acquired by an electronic device; second, a mounting position of a projection device and positions of at least two target projection regions configured by a user in the three-dimensional spatial model are acquired; and finally, the mounting position of the projection device and the positions of the at least two target projection regions in the three-dimensional spatial model are sent to the projection device, such that the projection device calculates projection angles corresponding to the at least two target projection regions based on the mounting position of the projection device and the positions of the at least two target projection regions in the three-dimensional spatial model, and adjusts a projection direction based on the projection angles corresponding to the at least two target projection regions to perform motion-based projection. According to the present application, the movement path for motion-based projection may be customized, the target projection regions traveled by the movement path are accurately positioned with no need of on-site adjustment, and the movement path may be modified and reused at will.

### Fifth Embodiment

The fifth embodiment of the present application provides a computer readable storage medium. The computer readable storage medium stores one or more computer programs. The one or more computer programs, when run by one or more processors, for example, the processor 601 as illustrated in FIG. 6, cause the one or more processors to perform the method for customizing motion-based projection in any of the above method embodiments, for example, performing step S201 to step S203 in the method as illustrated in FIG. 2, and step S301 to S305 in the method as illustrated in FIG. 3; and implementing the functions of modules 502 to 506 as illustrated in FIG. 5.

The above-described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objects of the technical solutions of the embodiments.

According to the above embodiments of the present application, a person skilled in the art may clearly understand that the embodiments of the present application may be implemented by means of hardware or by means of software plus a necessary general hardware platform. Based on such understanding, portions of the technical solutions of the present application that essentially contribute to the related art may be embodied in the form of a software product, the computer software product may be stored in a computer-readable storage medium, such as a read-only memory (ROM)/random-access memory (RAM), a magnetic disk, or a compact disc read-only memory (CD-ROM), including several instructions for causing a computer device (a personal computer, a server, or a network device) to perform the method in various embodiments of the present application or some of the embodiments.

Finally, it should be noted that the above embodiments are merely used to illustrate the technical solutions of the present application rather than limiting the technical solutions of the present application. Under the concept of the present application, the technical features of the above embodiments or other different embodiments may be combined, the steps therein may be performed in any sequence, and various variations may be derived in different aspects of the present application, which are not detailed herein for brevity of description. Although the present application is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present application.

1. A method for customizing motion-based projection, applicable to an electronic device, the method comprising:
acquiring, by the electronic device, a three-dimensional spatial model corresponding to an actual projection environment;
acquiring a mounting position of a projection device and positions of at least two target projection regions configured by a user in the three-dimensional spatial model; and
sending the mounting position of the projection device and the positions of the at least two target projection regions in the three-dimensional spatial model to the projection device.

2. The method for customizing motion-based projection according to claim 1, wherein the step of acquiring the mounting position of the projection device and the positions of the at least two target projection regions configured by the user in the three-dimensional spatial model comprises:
acquiring the mounting position of the projection device configured by the user in the three-dimensional spatial model;
calculating a projection region coverage range of the projection device based on the three-dimensional spatial model, the mounting position of the projection device, and parameter information of the projection device; and
acquiring positions of the at least two target projection regions configured by the user within the projection region coverage range.

3. The method for customizing motion-based projection according to claim 1, further comprising:
acquiring position coordinates of the mounting position of the projection device and position coordinates of the at least two target projection regions in a coordinate system of the three-dimensional spatial model
converting the position coordinates of the at least two target projection regions in the coordinate system of the three-dimensional spatial model to a relative position coordinate in a projection device coordinate system, wherein the mounting position of the projection device is the coordinate origin of the projection device coordinate system; and
sending the relative position coordinates of the at least two target projection regions in the coordinate system of the projection device to the projection device.

4. The method for customizing motion-based projection according to claim 1, further comprising:
acquiring a corresponding projection content configured by the user for each of the at least two target projection regions;
establishing a mapping relationship between the at least two target projection regions and the projection contents; and
sending the mapping relationship and the projection contents to the projection device.

5. The method for customizing motion-based projection according to claim 4, further comprising:
acquiring sizes and positions of the at least two target projection regions configured by the user in the three-dimensional spatial model, and
sending the sizes and positions of the at least two target projection regions in the three-dimensional spatial model to the projection device; wherein the sizes and positions of the at least two target projection regions are determined by at least one positioning point in the three-dimensional spatial model and at least one fixed length to the at least one positioning point, or determined by at least two positioning points in the three-dimensional spatial model.

6. The method for customizing motion-based projection according to claim 4, further comprising:
calculating, by the projection device based on the mounting position of the projection device and the positions of the at least two target projection regions in the three-dimensional spatial model, projection angles corresponding to the at least two target projection regions; and
adjusting a projection direction based on the projection angles corresponding to the at least two target projection regions, and acquiring the projection contents corresponding to the at least two target projection regions to perform motion-based projection.

7. The method for customizing motion-based projection according to claim 4, further comprising:
calculating, by the projection device based on the mounting position of the projection device and the positions of the at least two target projection regions in the three-dimensional spatial model, projection angles corresponding to the at least two target projection regions;
calculating, based on the sizes of the at least two target projection regions in the three-dimensional spatial model, projection sizes corresponding to the at least two target projection regions; and
adjusting the projection direction based on the projection angles corresponding to the at least two target projection regions;
acquiring the projection contents corresponding to the at least two target projection regions, and performing motion-based projection for the projection contents based on the projection sizes.

8. An electronic device, comprising:
at least one processor; and
a memory communicably connected to the at least one processor;
wherein the memory stores one or more instructions executable by the at least one processor, wherein, the one or more instructions, when executed by the at least one processor, cause the at least one processor to perform a method for customizing motion-based projection, wherein the method comprises:
acquiring, by the electronic device, a three-dimensional spatial model corresponding to an actual projection environment;
acquiring a mounting position of a projection device and positions of at least two target projection regions configured by a user in the three-dimensional spatial model; and
sending the mounting position of the projection device and the positions of the at least two target projection regions in the three-dimensional spatial model to the projection device.

9. The electronic device according to claim 8, wherein the step of acquiring the mounting position of the projection device and the positions of the at least two target projection regions configured by the user in the three-dimensional spatial model comprises:
acquiring the mounting position of the projection device configured by the user in the three-dimensional spatial model:
calculating a projection region coverage range of the projection device based on the three-dimensional spatial model, the mounting position of the projection device, and parameter information of the projection device; and
acquiring positions of the at least two target projection regions configured by the user within the projection region coverage range.

10. The electronic device according to claim 8, wherein the method further comprises:
acquiring position coordinates of the mounting position of the projection device and position coordinates of the at least two target projection regions in a coordinate system of the three-dimensional spatial model;
converting the position coordinates of the at least two target projection regions in the coordinate system of the three-dimensional spatial model to a relative position coordinate in a projection device coordinate system, wherein the mounting position of the projection device is the coordinate origin of the projection device coordinate system; and
sending the relative position coordinates of the at least two target projection regions in the coordinate system of the projection device to the projection device.

11. The electronic device according to claim 8, wherein the method further comprises:
acquiring a corresponding projection content configured by the user for each of the at least two target projection regions;
establishing a mapping relationship between the at least two target projection regions and the projection contents; and
sending the mapping relationship and the projection contents to the projection device.

12. The electronic device according to claim 11, wherein the method further comprises:
acquiring sizes and positions of the at least two target projection regions configured by the user in the three-dimensional spatial model, and
sending the sizes and positions of the at least two target projection regions in the three-dimensional spatial model to the projection device; wherein the sizes and positions of the at least two target projection regions are determined by at least one positioning point in the three-dimensional spatial model and at least one fixed length to the at least one positioning point, or determined by at least two positioning points in the three-dimensional spatial model.

13. The electronic device according to claim 11, wherein the method further comprises:
calculating, by the projection device based on the mounting position of the projection device and the positions of the at least two target projection regions in the three-dimensional spatial model, projection angles corresponding to the at least two target projection regions; and
adjusting a projection direction based on the projection angles corresponding to the at least two target projection regions, and acquiring the projection contents corresponding to the at least two target projection regions to perform motion-based projection.

14. The electronic device according to claim 11, wherein the method further comprises:
calculating, by the projection device based on the mounting position of the projection device and the positions of the at least two target projection regions in the three-dimensional spatial model, projection angles corresponding to the at least two target projection regions;
calculating, based on the sizes of the at least two target projection regions in the three-dimensional spatial model, projection sizes corresponding to the at least two target projection regions; and
adjusting the projection direction based on the projection angles corresponding to the at least two target projection regions;
acquiring the projection contents corresponding to the at least two target projection regions, and performing motion-based projection for the projection contents based on the projection sizes.

15. A motion-based projection system, comprising a projection device and an electronic device communicably connected to the projection device wherein the electronic device is configured to:
acquire a three-dimensional spatial model corresponding to an actual projection environment; acquire a mounting position of a projection device and positions of at least two target projection regions configured by a user in the three-dimensional spatial model; and send the mounting position of the projection device and the positions of the at least two target projection regions in the three-dimensional spatial model to the projection device; and
the projection device is configured to calculate, based on the mounting position of the projection device and the positions of the at least two target projection regions in the three-dimensional spatial model, projection angles corresponding to the at least two target projection regions; and adjust a projection direction based on the projection angles corresponding to the at least two target projection regions to perform motion-based projection.

16. The motion-based projection system according to claim 15, wherein the step of acquiring the mounting position of the projection device and the positions of the at least two target projection regions configured by the user in the three-dimensional spatial model comprises:
acquiring the mounting position of the projection device configured by the user in the three-dimensional spatial model;
calculating a projection region coverage range of the projection device based on the three-dimensional spatial model, the mounting position of the projection device, and parameter information of the projection device; and
acquiring positions of the at least two target projection regions configured by the user within the projection region coverage range.

17. The motion-based projection system according to claim 15, wherein the electronic device is further configured to acquire position coordinates of the mounting position of the projection device and position coordinates of the at least two target projection regions in a coordinate system of the three-dimensional spatial model;
convert the position coordinates of the at least two target projection regions in the coordinate system of the three-dimensional spatial model to a relative position coordinate in a projection device coordinate system, wherein the mounting position of the projection device is the coordinate origin of the projection device coordinate system; and
send the relative position coordinates of the at least two target projection regions in the coordinate system of the projection device to the projection device.

18. The motion-based projection system according to claim 15, wherein
the electronic device is further configured to: acquire a corresponding projection content configured by the user for each of the at least two target projection regions; establish a mapping relationship between the at least two target projection regions and the projection contents; and send the mapping relationship and the projection contents to the projection device; and
the projection device is further configured to calculate, based on the mounting position of the projection device and the positions of the at least two target projection regions in the three-dimensional spatial model, projection angles corresponding to the at least two target projection regions; and adjust the projection direction based on the projection angles corresponding to the at least two target projection regions, and acquire the projection contents corresponding to the at least two target projection regions to perform motion-based projection.

19. The motion-based projection system according to claim 15, wherein the electronic device is further configured to acquire sizes and positions of the at least two target projection regions configured by the user in the three-dimensional spatial model; and send the sizes and positions of the at least two target projection regions to the projection device; and
the projection device is further configured to: calculate, based on the mounting position of the projection device and the positions of the at least two target projection regions in the three-dimensional spatial model, projection angles corresponding to the at least two target projection regions; calculate, based on the sizes of the at least two target projection regions in the three-dimensional spatial model, projection sizes corresponding to the at least two target projection regions; and adjust the projection direction based on the projection angles corresponding to the at least two target projection regions, and acquire the projection contents corresponding to the at least two target projection regions, and perform motion-based projection for the projection contents based on the projection sizes.

20. The motion-based projection system according to claim 18, wherein he electronic device is further configured to acquire sizes and positions of the at least two target projection regions configured by the user in the three-dimensional spatial model; and send the sizes and positions of the at least two target projection regions to the projection device, wherein the sizes and positions of the at least two target projection regions are determined by at least one positioning point in the three-dimensional spatial model and at least one fixed length to the at least one positioning point, or determined by at least two positioning points in the three-dimensional spatial model; and
the projection device is further configured to: calculate, based on the mounting position of the projection device and the positions of the at least two target projection regions in the three-dimensional spatial model, projection angles corresponding to the at least two target projection regions; calculate, based on the sizes of the at least two target projection regions in the three-dimensional spatial model, projection sizes corresponding to the at least two target projection regions; and adjust the projection direction based on the projection angles corresponding to the at least two target projection regions, and acquire the projection contents corresponding to the at least two target projection regions, and perform motion-based projection for the projection contents based on the projection sizes.
